(19) United States
(12) Patent Application Publication
(10) Pub. No.: US 2016/0059904 A1
(43) Pub. Date: Mar. 3, 2016

(54) Crash Structure for a Vehicle

(71) Applicant: Bayerische Motoren Werke Aktiengesellschaft, Muenchen (DE)

(72) Inventors: Stefan KERSCHER, Steinkirchen (DE); Jyrki MAJAMAEKI, Dorfen (DE); Christian BOEGLE, Muenchen (DE); Dirk LUKASZEWICZ, Augsburg (DE); Balazs FODOR, Markt Schwaben (DE)

(21) Appl. No.: 14/934,353

(22) Filed: Nov. 6, 2015

Related U.S. Application Data
(63) Continuation of application No. PCT/EP2014/059080, filed on May 5, 2014.

(30) Foreign Application Priority Data
May 16, 2013 (DE) 10 2013 209 095.1

(51) Int. Cl. B62D 29/04; B62D 21/15

(52) U.S. Cl. CPC B62D 29/04; B62D 21/15

(57) ABSTRACT

A crash structure is provided for a vehicle. The crash structure includes at least two carriers produced of fiber-reinforced plastic, and at least one planar element produced of fiber-reinforced plastic. The planar element is connected to both carriers to avoid buckling of the carrier in the event of a crash.

### CROSS REFERENCE TO RELATED APPLICATIONS

This application is a continuation of PCT International Application No. PCT/EP2014/059080, filed May 5, 2014, which claims priority under 35 U.S.C. §119 from German Patent Application No. 10 2013 209 095.1, filed May 16, 2013, the entire disclosures of which are herein expressly incorporated by reference.

### BACKGROUND AND SUMMARY OF THE INVENTION

The present invention relates to a crash structure made of fiber-reinforced plastic for a vehicle. The invention further relates to a corresponding vehicle with the crash structure.

Crash structures in a vehicle are components of the body that are deformed in an accident in order to dissipate the impact energy. In the front carriage, the longitudinal carriers represent typical crash structures that are deformed during a collision. The crash structures in vehicles are typically made of steel or aluminum. Crash structures of fiber-reinforced plastic used in the prior art are purely carrier structures which only represent a material substitution for steel or aluminum. Crash structures made of steel or aluminum have the drawback that they are substantially more difficult to build than fiber-reinforced plastics. The known carrier structures made of fiber-reinforced plastic easily buckle under an oblique load and thus do not perform any robust crash function. As a result of a simple material substitution in the body design, when fiber-reinforced plastics are used, a longer front end or a longer front carriage is needed in order to achieve similar functions as those achieved with steel or aluminum.

It is the object of the present invention to provide a crash structure for a vehicle, as well as a vehicle with the crash structure, that are cost-effective to manufacture and require little maintenance to operate while enabling a crash-optimized, light and robust construction.

This and other objects are thus achieved by a crash structure for a vehicle comprising at least two carriers made of fiber-reinforced plastic and at least one planar element made of fiber-reinforced plastic. The planar element is connected to both of the carriers. The planar element is arranged in order to prevent buckling of the carriers during a crash, i.e., a collision of the vehicle with another object.

Through the planar element, the carriers are fixed in a defined alignment. In the event of a crash (collision), the carrier thus does not buckle; instead, compression occurs, which results in the breaking of the carrier at a great number of points arranged successively one behind the other. Because the carrier breaks at a great number of points, a commensurately large amount of energy can thus be dissipated during the crash. With the carriers, the planar element of fiber-reinforced plastic also remains in a defined position during the crash. The carriers thus ensure that the planar element does not buckle. As a result, the planar element can also absorb energy during impact.

The invention thus provides a planar, multidimensional crash structure comprising at least the two carriers and the planar element. Since both the carriers and the planar element are made of fiber-reinforced plastic, the lightweight construction potential of this material is fully exploited. Since the carriers and the planar element mutually stabilize each other, sufficient impact energy is able to be dissipated in the event of oblique force input, that is, force input oblique to the carrier longitudinal direction.

According to the invention, the design does not simply use fiber-reinforced plastic to emulate the design of a conventional steel or aluminum body (substitution by fiber-reinforced plastic), but rather the vehicle is designed on the basis of the crash structure according to the invention. As a result, a relatively short front carriage and rear carriage can be implemented. The deformation sequence can be adapted according to the design of the crash structure. The planar element is provided first and foremost to stabilize the carriers. It prevents the carriers from buckling away only under oblique stress, whereby the carriers break progressively together with the planar element under such a transverse load.

Carbon fiber-reinforced plastic or glass fiber-reinforced plastic is preferably used as the fiber-reinforced plastic. Braided components are particularly used for the carriers. An optimal energy exploitation of the braided structures preferably occurs through a certain geometric ratio and through certain proportions of braided to stationary threads, so that the crash structure fails appropriately during impact and the maximum amount of energy can be dissipated per length. Corresponding force levels can be controlled by way of the braid angle.

Preferably, a provision is made that the carriers of the crash structure have a hollow cross section, i.e., a hollow profile. In particular, the hollow cross section is a closed tubular cross section. As an alternative to the closed tubular cross section, open cross sections are provided. The carriers have the function in the vehicle of receiving the engine, for example. Through appropriate structuring of the cross sections, the carriers can absorb corresponding loads.

The planar element is preferably formed by use of the following various methods. For one, the planar element is formed by a sandwich structure of at least two spaced-apart fiber-reinforced plastic plates. Alternatively, a single corrugated fiber-reinforced plastic plate is used. In the third alternative, the planar element is composed of a single flat fiber-reinforced plastic plate. There are also various structural possibilities for the sandwich structure. For instance, the two plastic plates can be spaced apart from one another in the sandwich by a foam, by honeycombs or by a corrugated plate. The foam is preferably composed of plastic. The honeycombs are preferably made of paper, plastic or aluminum. The corrugated plate, as the spacer in the sandwich, is preferably made of a plastic or a fiber-reinforced plastic. The planar element is preferably connected directly to the at least two carriers. This is particularly achieved through an integral connection. The integral connection is preferably achieved through adhesion or through integral manufacture of the carriers with the planar element. The planar element preferably has a thickness from 10 mm to 50 mm, preferably 15 mm to 40 mm. A diameter is defined in the cross section of the carriers. In determining the diameter, the largest diameter is preferably measured. This diameter is at least 150%, preferably at least 200%, especially preferably at least 250%, of the thickness of the planar element.

The invention further comprises a vehicle with at least one of the crash structures described above. A passenger compartment and at least one front carriage are defined on the vehicle. The crash structure is located particularly in the front carriage. The at least two carriers extend partially in the vehicle longitudinal direction. Moreover, a provision is made that the crash structure is not only used in the front carriage, but also in the rear carriage or in the passenger compartment.

In a preferred embodiment, each of the two carriers of the crash structure represents a longitudinal carrier in the vehicle. These longitudinal carriers are preferably used to receive an engine in the front carriage.

The two carriers of the crash structure preferably form a bearing structure in the front carriage of the vehicle. For instance, the undercarriage is connected to these carriers.

In a preferred manner, the at least two carriers extend in the vehicle longitudinal direction over the entire front carriage of the vehicle. Therefore, not only parts of the longitudinal carriers are made of fiber-reinforced plastic, but rather the entire longitudinal carrier, at least in the front carriage area, is made of fiber-reinforced plastic. The carriers extend particularly from the bumper at least to a front cowl. Preferably, it is provided that the two carriers extend not only to the front carriage, but rather into the passenger compartment. In particular, the carriers transition directly into a roof frame, into a door sill, into a longitudinal tunnel and/or into a side frame of the vehicle. Especially preferably, the carriers extend over the entire length of the vehicle, that is, over the front carriage, over the passenger compartment, and all the way to the rear axle. Especially preferably, the carriers are made of fiber-reinforced plastic over their entire length.

The at least one planar element is preferably formed through appropriate embodiment of a component of the vehicle that is already present in any case. Accordingly, the planar element of fiber-reinforced plastic is preferably a wheelhouse of the vehicle, a component of the undercarriage or an engine hood. Especially preferably, a provision is made that a portion of the undercarriage or the entire undercarriage of the vehicle is embodied as a planar element of the crash structure. In particular, at least the entire undercarriage in the front carriage is embodied as a planar element of the crash structure.

Moreover, a provision is preferably made, in addition or alternatively to the carriers that are embodied as longitudinal carriers, that diagonally running carriers of the crash structure are arranged in the front carriage. In particular, two mutually crossing carriers are used. The two carriers can also be embodied as an integral unit. The diagonally running carriers particularly constitute a lattice structure in the front carriage.

Moreover, a provision is preferably made that the front carriage is separated from the passenger compartment by a massive partition wall. The partition wall is preferably made of fiber-reinforced plastic. The carriers of the crash structure either end at the partition wall or run past the partition wall and transition into the door sill, for example.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective view of a crash structure according to an embodiment of the invention, the crash structure being usable in a vehicle,

FIG. 2 shows an inventive vehicle according to a first exemplary embodiment;

FIG. 3 is an isometric view of the crash structure of the inventive vehicle according to the first exemplary embodiment;

FIG. 4 is a sectional view of the crash structure of the inventive vehicle according to the first exemplary embodiment;

FIG. 5 shows the inventive vehicle according to a second exemplary embodiment;

FIG. 6 is an isometric view of the crash structure of the inventive vehicle according to the second exemplary embodiment;

FIG. 7 is the inventive vehicle according to a third exemplary embodiment,

FIG. 8 an isometric view of the crash structure of the inventive vehicle according to a third exemplary embodiment; and

FIG. 9 is a sectional view of the crash structure of the inventive vehicle according to the third exemplary embodiment.

### DETAILED DESCRIPTION OF THE DRAWINGS

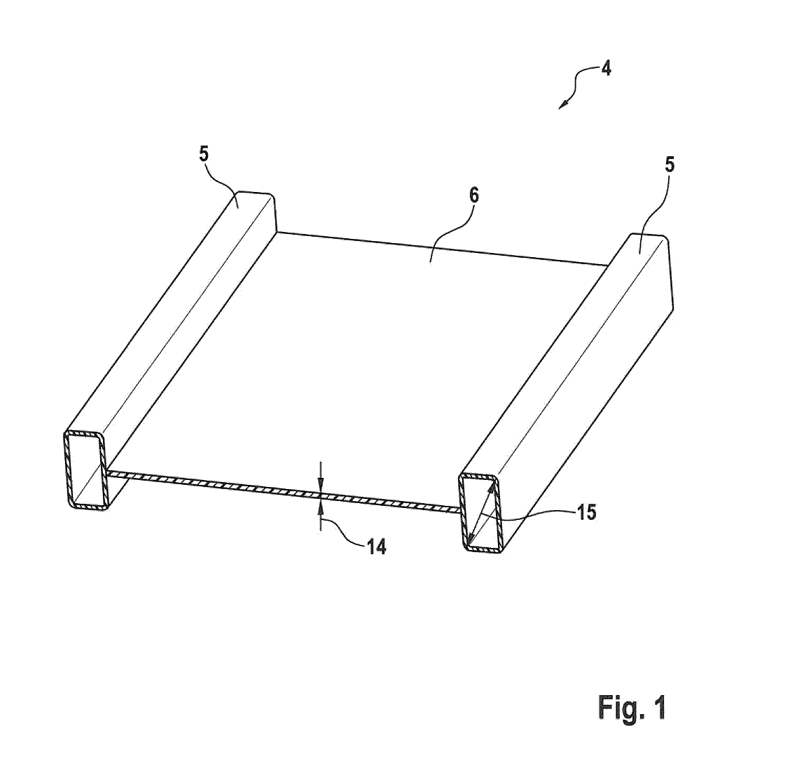

FIG. 1 shows the general construction of a crash structure 4. This crash structure 4 is used in the vehicles 1 of the three exemplary embodiments in different designs.

The crash structure 4 has at least two spaced-apart carriers 5 made of a fiber-reinforced plastic and at least one planar element 6 made of fiber-reinforced plastic. The planar element 6 extends between the two carriers 5 and is firmly connected to the two carriers 5. In particular, the planar element 6 is integrally connected to the two carriers 5. For this purpose, the planar element 6 can either be adhered to the carriers 5 or the entire crash structure 4 may be manufactured as an integral unit.

Both the carriers 5 and the planar element 6 are made of fiber-reinforced plastic, particularly of carbon fiber-reinforced plastic. It is possible for metal parts to be introduced into the carriers 5 or into the planar element 6 in order to represent screwing points for bearings, for example. As FIG. 1 shows, the carriers 5 have a diameter 15. The diameter 15 is substantially larger than a thickness 14 of the planar element 6. FIG. 1 shows the crash structure 4 in a schematic, simplified representation. As will readily be understood, the carriers 5 and the planar element 6 can be designed differently depending on the requirements in the respective vehicle 1.

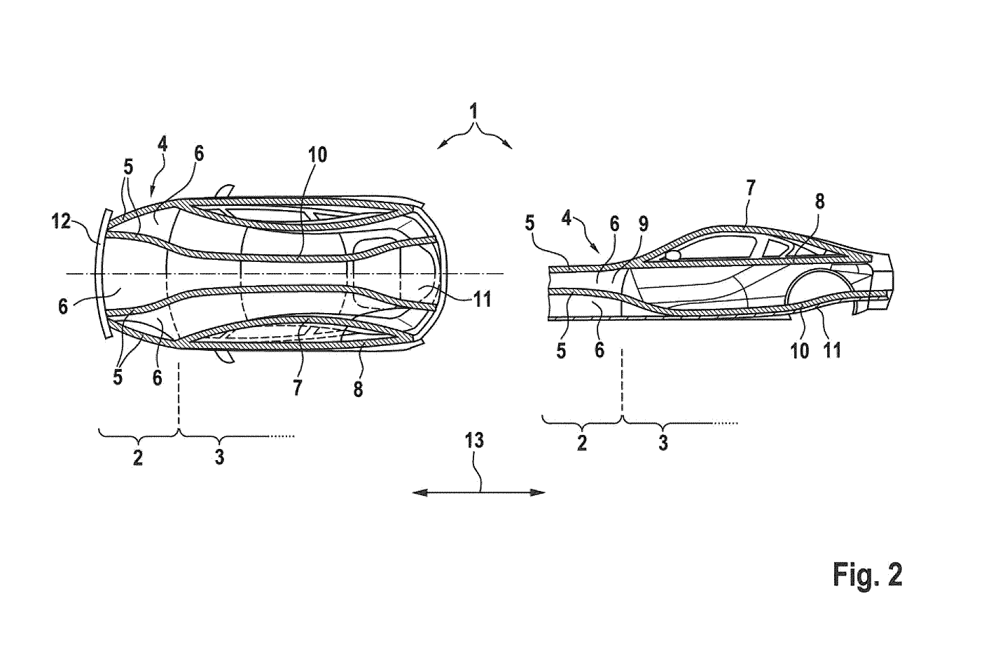

FIGS. 2, 5 and 7 each show an exemplary embodiment of a vehicle 1 with the crash structure 4. In FIGS. 2, 5 and 7, the vehicle is shown in a schematically simplified top and side view. Same or functionally similar components are designated by the same reference symbols in all of the exemplary embodiments.

According to FIG. 2, a front carriage 2 and a passenger compartment 3 are defined on the vehicle 1. FIG. 2 also shows the vehicle longitudinal direction 13 and a bumper 12 of the vehicle 1. The crash structure 4 with the carriers 5 and the planar elements 6 is particularly located in the front carriage 2. However, as the exemplary embodiments show, the carriers 5 and/or the planar elements 6 extend over the front carriage 2 into the passenger compartment 3 and partially all the way to the rear axle of the vehicle 1. According to FIG. 2, the crash structure 4 in the front carriage 2 is formed by four carriers 5. The carriers 5 continue into the passenger compartment 3 and form there a roof frame 7, a side frame 8 and a longitudinal tunnel 10.

The planar elements 6 form an undercarriage 11 as well as the two lateral wheelhouses 9 in the front carriage 2. The undercarriage 11 extends not only over the front carriage 2, but also over the passenger compartment 3.

At least in the front carriage 2, the carriers 5 and the planar elements 6 are made of a fiber-reinforced plastic. Preferably, the embodiment of these elements made of fiber-reinforced plastic extend over the entire vehicle 1.

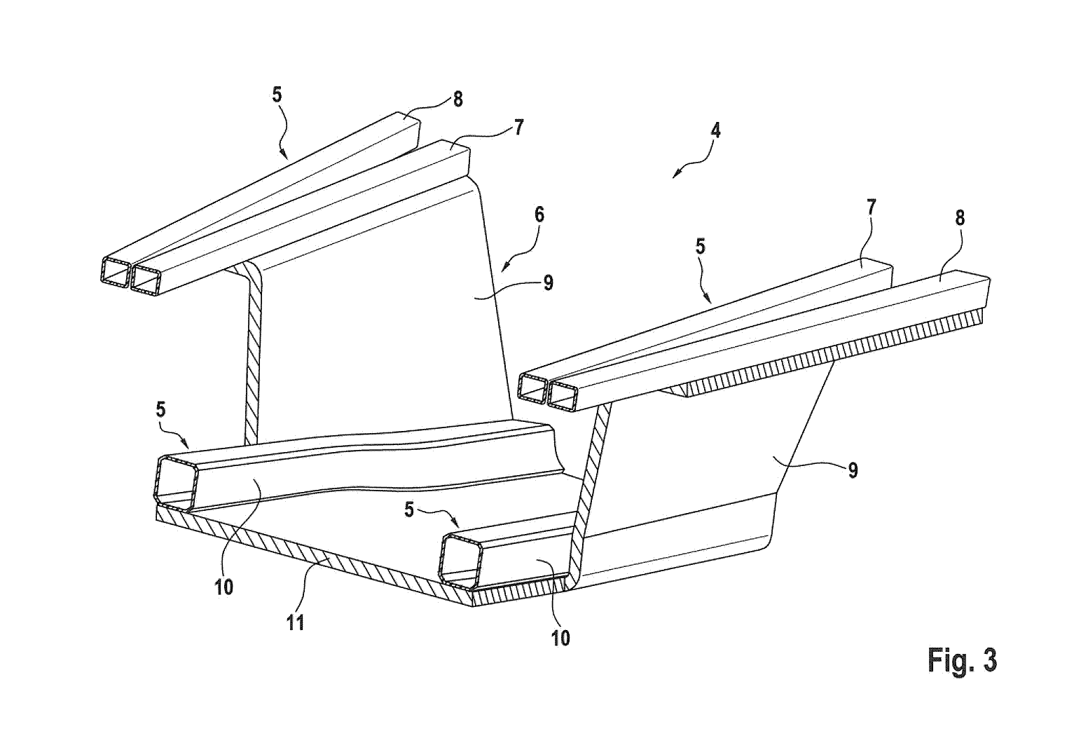

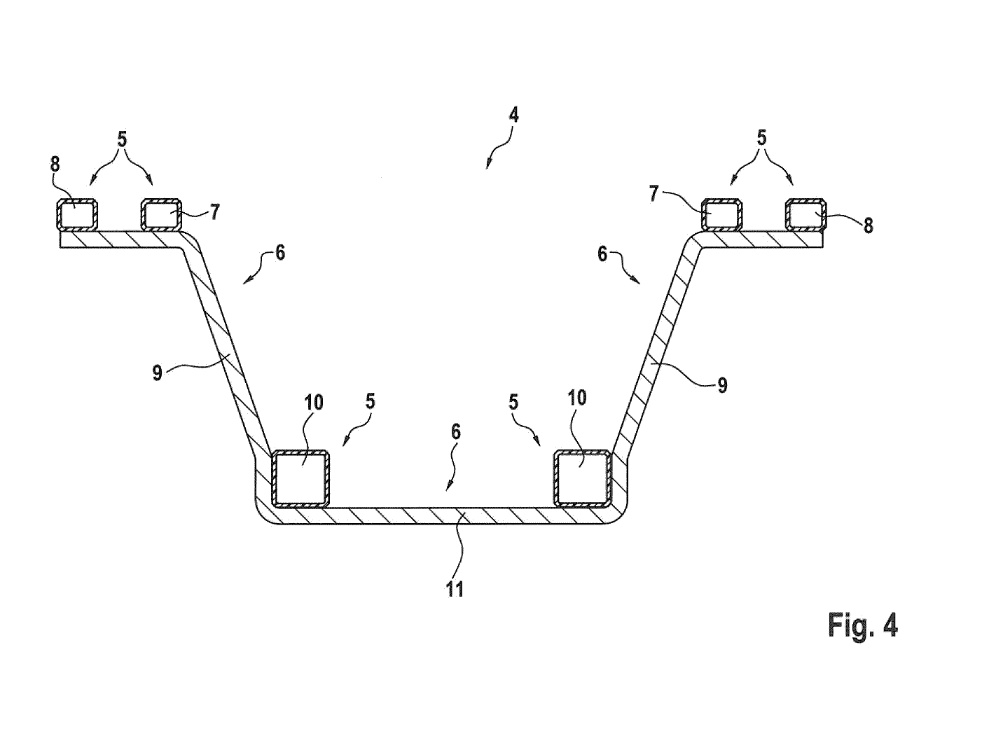

FIGS. 3 and 4 provide a detailed illustration of the crash structure 4 in the first exemplary embodiment. FIG. 3 shows an isometric view. FIG. 4 shows a sectional view. The planar element 6 of the crash structure 4 is a surface bent into a U-shape, so that the two wheelhouses 9 and the undercarriage 11 are formed from a continuous planar element 6. As an alternative to this, it is also possible for the two wheelhouses 9 and the undercarriage 11 to be formed from individual planar elements 6. What is crucial is that the planar elements 6 be firmly connected to the carriers 5. This results in a three-dimensional, partially planar crash structure 4. This crash structure 4 retains its shape during a crash and does not buckle. Energy dissipation is thus made possible through the stepwise breaking of the fiber-reinforced plastic.

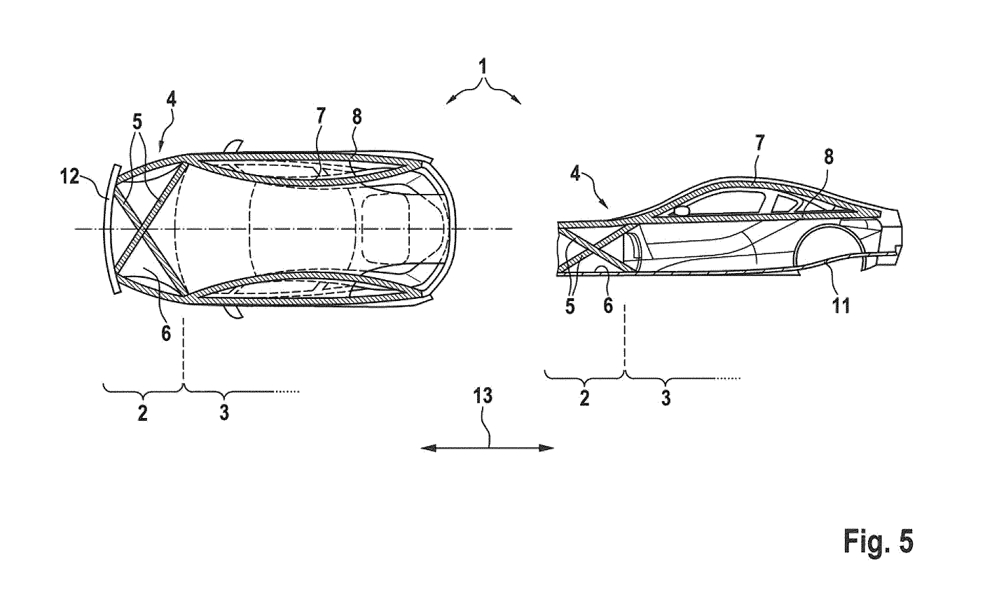

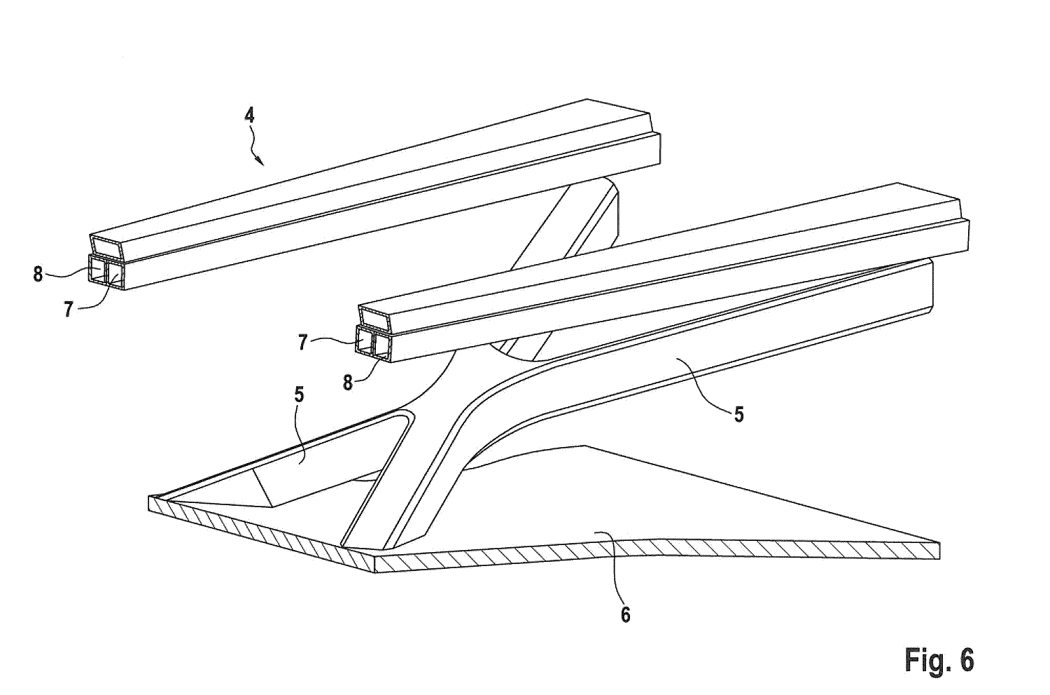

FIG. 5 shows the vehicle 1 according to the second exemplary embodiment. FIG. 6 shows, for the second exemplary embodiment, the crash structure 4 in an isometric view. In the second exemplary embodiment, the planar element 6 is embodied as undercarriage 11. The roof frame 7 and the side frame 8 are provided in the upper area. The roof frame 7 and the side frame 8 are connected via the carriers 5 to the undercarriage 11. The two carriers 5 extend diagonally in the front carriage 2, so that a lattice is formed by the two carriers 5. The ends of the two carriers 5, in turn, are connected to the planar element 6, which is embodied as undercarriage 11. In the second exemplary embodiment, at least the two diagonally running carriers 5 and the planar element 6 are made of fiber-reinforced plastic. Moreover, a provision is preferably made here that the roof frame 7 and the side frame 8 are made of fiber-reinforced plastic.

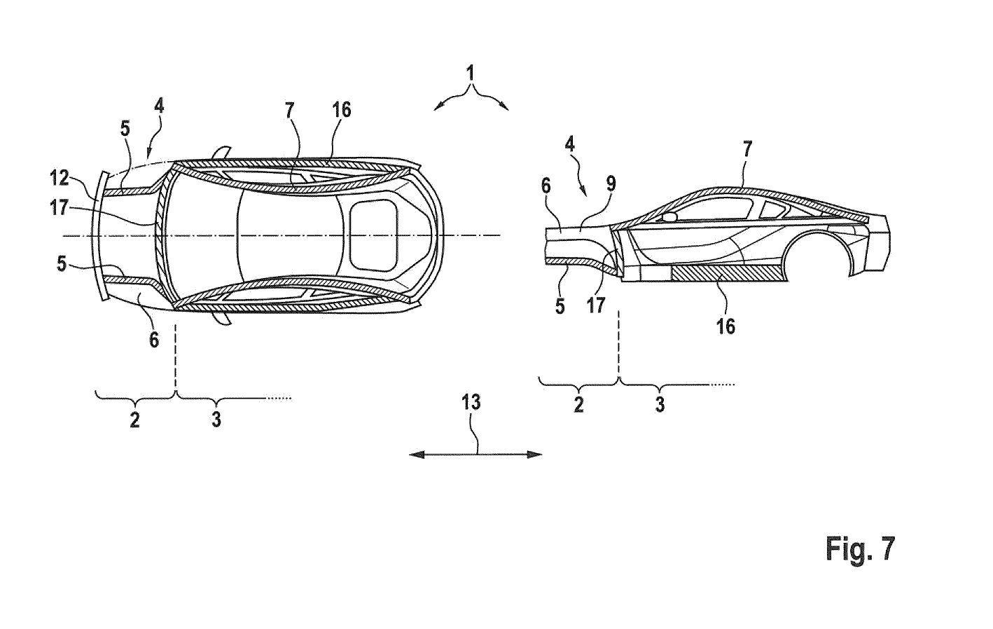

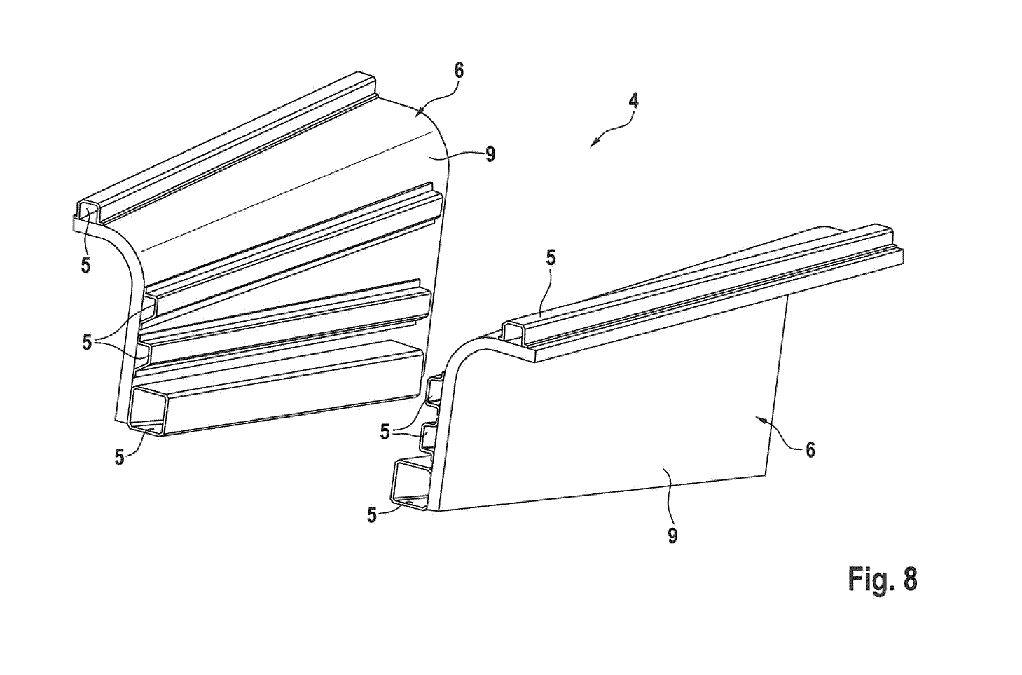

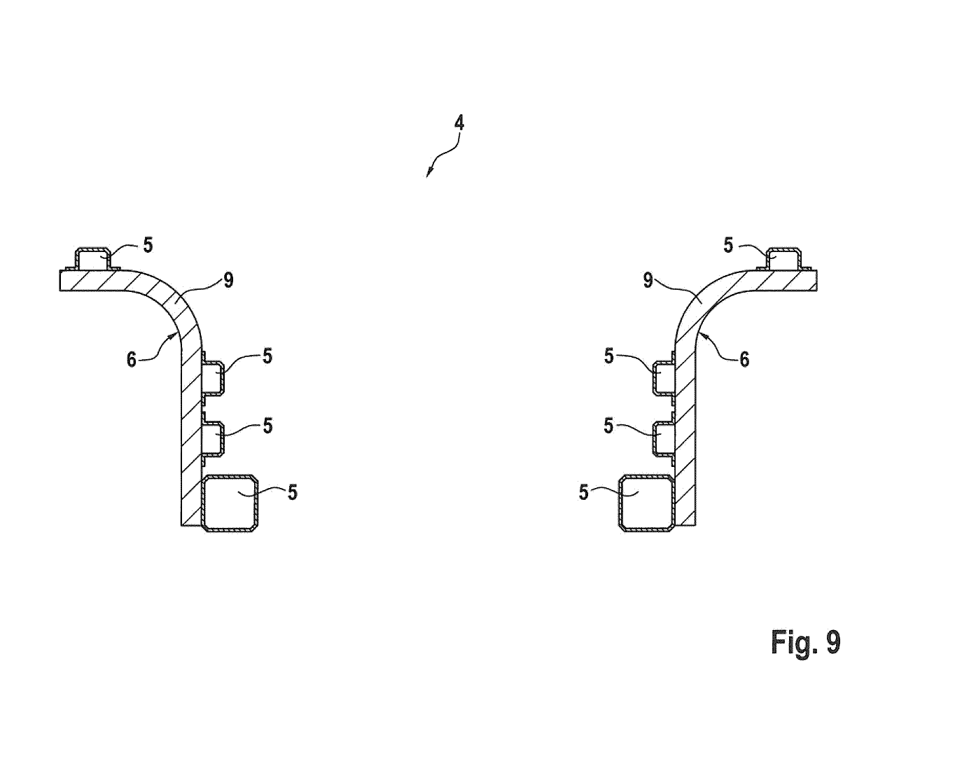

FIG. 7 shows the vehicle 1 according to the third exemplary embodiment. FIGS. 8 and 9 show the crash structure 4 of the third exemplary embodiment.

In the third exemplary embodiment, a partition wall 17 made of fiber-reinforced plastic is located between the front carriage 2 and the passenger compartment 3. The several carriers 5 of the crash structure 4 run forward from this partition wall 17 to the bumper 12. On each side of the vehicle 1, several carriers 5 are provided that are interconnected by a planar element 6. The planar element 6, in turn, is embodied as a wheelhouse 9. In the third exemplary embodiment, a provision is made that the carriers 5 of the crash structure 4 end at the partition wall 17. Alternatively to this, it is possible for at least some of the carriers 5 to go past the partition wall 17 and transition into a door sill 16, into the roof frame 7 or the side frame 8.

All three exemplary embodiments show a crash structure 4 in the front carriage 2 of the vehicle 1. The carriers 5 made of fiber-reinforced plastic always extend over the entire front carriage 2 to the bumper 12. In addition, it is possible for the carriers 5 to continue from the front carriage 2 into the passenger compartment 3 and thus to embody the carriers 5 as a roof frame 7, side frame 8, longitudinal tunnel 10 or door sill 16. The carriers 5 of the crash structure 4 are interconnected by the planar elements 6, also made of fiber-reinforced plastic, whereby a defined crash structure 4 is created. The planar elements 6, in turn, are preferably not elements that are additionally incorporated into the body, but rather simultaneously perform another function, for example as a wheelhouse 9, undercarriage 11 or engine hood.

### LIST OF REFERENCE SYMBOLS

1 vehicle
2 front carriage
3 passenger compartment
4 crash structure
5 carriers
6 planar elements
7 roof frame
8 side frame
9 wheelhouse
10 longitudinal tunnel
11 undercarriage
12 bumper
13 vehicle longitudinal direction
14 thickness
15 diameter
16 door sill
17 partition wall

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A crash structure for a vehicle, comprising:
at least two carriers made of fiber-reinforced plastic; and
at least one planar element made of fiber-reinforced plastic;
wherein the planar element is connected to both carriers in order to prevent buckling of the carriers during a crash.

2. The crash structure according to claim 1, wherein the carriers have a hollow cross section.

3. The crash structure according to claim 1, wherein the carriers have a closed tubular cross-section.

4. The crash structure according to claim 1, wherein the planar element comprises one of:
a sandwich structure having at least two spaced-apart fiber-reinforced plastic plates,
a corrugated fiber-reinforced plastic plate, or
a single fiber-reinforced plastic plate.

5. The crash structure according to claim 1, wherein the planar element is connected directly to the at least two carriers made of fiber-reinforced plastic.

6. The crash structure according to claim 1, wherein the planar element is integrally connected to the at least two carriers made of fiber-reinforced plastic.

7. The crash structure according to claim 1, wherein the planar element has a thickness from 10 mm to 50 mm.

8. The crash structure according to claim 1, wherein the planar element has a thickness from 15 mm to 40 mm.

9. The crash structure according to claim 1, wherein a diameter of the at least two carriers is at least 150% of a thickness of the planar element.

10. The crash structure according to claim 7, wherein a diameter of the at least two carriers is at least 200% of the thickness of the planar elements.

11. The crash structure according to claim 8, wherein a diameter of the at least two carriers is at least 250% of the thickness of the planar elements.

12. A vehicle, comprising:
a passenger compartment;
a front carriage, wherein the front carriage comprises at least one crash structure having:
at least two carriers made of fiber-reinforced plastic; and
at least one planar element made of fiber-reinforced plastic;
wherein the planar element is connected to both carriers in order to prevent buckling of the carriers during a crash;
wherein the at least two carriers of the at least one crash structure extend at least partially in a vehicle longitudinal direction.

13. The vehicle according to claim 12, wherein the at least two carriers each form a longitudinal carrier of the vehicle adapted to receive an engine.

14. The vehicle according to claim 12, wherein the at least two carriers of the at least one crash structure form a bearing structure in the front carriage of the vehicle.

15. The vehicle according to claim 12, wherein the at least two carriers of the at least one crash structure extend in a vehicle longitudinal direction over an entirety of the front carriage of the vehicle.

16. The vehicle according to claim 12, wherein the at least two carriers transition directly into a roof frame, into a door sill, into a longitudinal tunnel, and/or into a side frame of the vehicle.

17. The vehicle according to claim 12, wherein the at least one planar element constitutes a wheelhouse of the vehicle.

18. The vehicle according to claim 12, wherein
the at least one planar element constitutes an undercarriage of the vehicle, and
the at least one planar element extends in a vehicle longitudinal direction over the front carriage and the passenger compartment.

19. The vehicle according to claim 12, wherein the at least two carriers extend diagonally in the front carriage of the vehicle.

20. The vehicle according to claim 12, further comprising a partition wall made of fiber-reinforced plastic, the partition wall being arranged between the front carriage and the passenger compartment.
